(19) United States
(12) Patent Application Publication
(10) Pub. No.: US 2025/0391154 A1
(43) Pub. Date: Dec. 25, 2025

(54) MEMORY BOOKMARK FOR ELECTRONICALLY CAPTURED VISUAL INFORMATION

(71) Applicant: Samsung Electronics Co., Ltd., Suwon-si (KR)

(72) Inventors: Jeewon Jung, San Francisco, CA (US); Vida M. Saffari, San Carlos, CA (US); Ross Rudolph, San Francisco, CA (US); Isabelle Pleno, Burlingame, CA (US); Zainul S. Shah, San Francisco, CA (US)

(21) Appl. No.: 18/751,968

(22) Filed: Jun. 24, 2024

(51) Int. Cl. G06V 10/70; G06F 9/54; G06V 10/82; G06V 10/94; G06V 20/50; G06V 20/62; G06V 30/19; G06V 30/30

(52) U.S. Cl. CPC G06V 10/768; G06F 9/54; G06V 10/82; G06V 10/945; G06V 20/50; G06V 30/191; G06V 20/62; G06V 30/30

(57) ABSTRACT

A method includes obtaining, by a processor, an image captured in response to an input from a user, the image comprising a screenshot or a photo. The method also includes processing, by the processor, the image using an intent-based image understanding model and an optical character recognition model to extract information from the image. The method further includes recommending, by the processor, at least one automatic action to be taken based on the extracted information. In addition, the method includes, in response to a validation by the user of the at least one automatic action, performing, by the processor, the at least one automatic action.

### TECHNICAL FIELD

This disclosure relates generally to consumer electronic devices. More specifically, this disclosure relates to memory bookmarks for electronically captured visual information in consumer electronic devices.

### BACKGROUND

The increased use of digital devices over the last several years is starting to cause an information overload among the general population. When interacting with devices today, users find that media and content are siloed in different applications (or “apps”). As a result, the overwhelming amount of information is often not found in one single place. This is known as “media multitasking,” which refers to users having to interact with different apps and media forms simultaneously on their devices.

### SUMMARY

This disclosure relates to memory bookmarks for electronically captured visual information in consumer electronic devices.

In a first embodiment, a method includes obtaining, by a processor, an image captured in response to an input from a user, the image comprising a screenshot or a photo. The method also includes processing, by the processor, the image using an intent-based image understanding model and an optical character recognition model to extract information from the image. The method further includes recommending, by the processor, at least one automatic action to be taken based on the extracted information. In addition, the method includes, in response to a validation by the user of the at least one automatic action, performing, by the processor, the at least one automatic action.

In a second embodiment, an electronic device includes at least one processing device configured to obtain an image captured in response to an input from a user, the image comprising a screenshot or a photo. The at least one processing device is also configured to process the image using an intent-based image understanding model and an optical character recognition model to extract information from the image. The at least one processing device is further configured to recommend at least one automatic action to be taken based on the extracted information. In addition, the at least one processing device is configured to, in response to a validation by the user of the at least one automatic action, perform the at least one automatic action.

In a third embodiment, a non-transitory machine readable medium includes instructions that when executed cause at least one processor to obtain an image captured in response to an input from a user, the image comprising a screenshot or a photo. The instructions also cause the at least one processor to process the image using an intent-based image understanding model and an optical character recognition model to extract information from the image. The instructions further cause the at least one processor to recommend at least one automatic action to be taken based on the extracted information. In addition, the instructions cause the at least one processor to, in response to a validation by the user of the at least one automatic action, perform the at least one automatic action.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example process for generating and using memory bookmarks for electronically captured visual information according to this disclosure;

FIG. 3 illustrates further details of an intent-based image understanding process in the process of FIG. 2 according to this disclosure;

FIG. 4 illustrates further details of one example of an intent-based image understanding process and an external context understanding process in the process of FIG. 2 according to this disclosure;

FIGS. 5A and 5B illustrate an example image from which information can be extracted using accessibility APIs according to this disclosure; and

FIG. 6 illustrates an example method for generating and using memory bookmarks for electronically captured visual information according to this disclosure.

### DETAILED DESCRIPTION

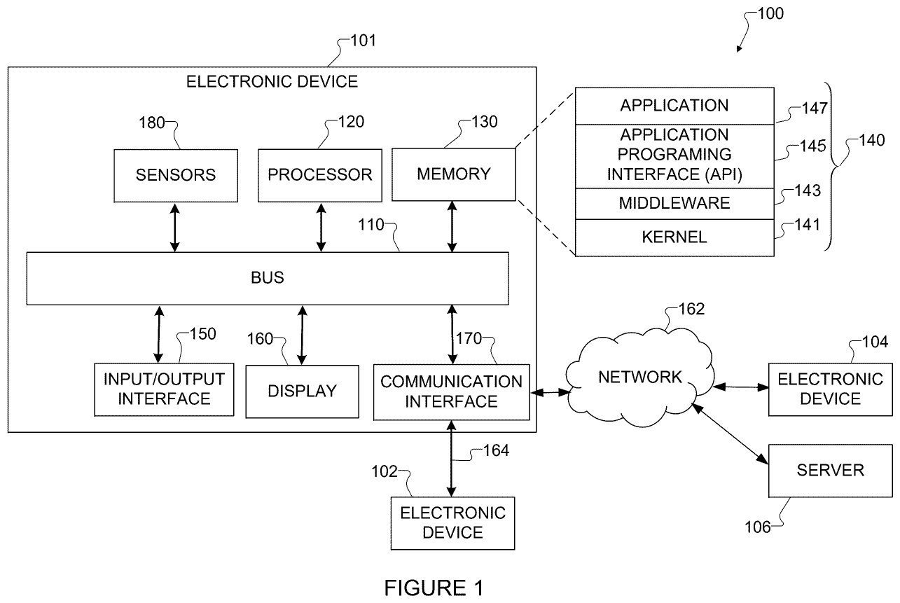

FIGS. 1 through 6, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, the increased use of digital devices over the last several years is starting to cause an information overload among the general population. When interacting with devices today, users find that media and content are siloed in different applications (or “apps”). As a result, the overwhelming amount of information is often not found in one single place. This is known as “media multitasking,” which refers to users having to interact with different apps and media forms simultaneously on their devices.

Device users often use photo apps and screenshots to capture and remember passing information on the screen or keep track of things. It helps them remember important information, events, products to buy, inspiration, and more for future reference. Some examples of information collected in screenshots can include recipes to make, funny pictures to send, places to visit, books to read, products to purchase, events to attend, credit cards and insurance cards, and receipts of purchases.

While people are using multiple devices to help them capture and remember digital information, over time, information overload and “media multitasking” can lead to reduced focus and memory. Some studies have shown a correlation between “media multitasking” and reduced episodic memory, attention lapses, and overall, reduced memory. Also, digital visual content and screenshots funneled into one place without intelligent organizational and actionable support can cause the content to be wasted and crowd the data space.

For example, people often forget that they have taken pictures or screenshots of passing information, and users end up wasting those images by not taking action promptly. It is not until they are looking through their photos later that they are reminded of the screenshot they had taken. In particular, the time-sensitive screenshots that are used as reminders may not be effective because the date might have expired. These captured images can lose their usefulness and fail as an aid to remembering things. Also, screenshots and informative photos can easily blend in with other photos, and users have to manually organize those into relevant categories and what kind of actions to be taken. It is a time-consuming process that most users do not want to put that much effort into doing.

Also, screenshots or photos contain information only in a static format and have limited amounts of metadata, such as usable source links or location/contextual information. Because the screenshots or photos lack interactivity, referencing the sources is difficult for users. Moreover, due to the increasing number of apps and media sources, there are disconnected and siloed methods of saving and taking action on the content that users come across and want to remember. This prevents them from remembering the content and easily accessing it.

In addition to the general population, there are other groups of individuals (such as neurodivergent users or the elderly population, as well as people with situational challenges such as tumors, head injuries, and lack of sleep) that have a heightened need for help maintaining focus and managing overwhelm in their digital environments in order to reduce mental stress. A key frustration with using mobile devices among neurodivergent users is being overwhelmed from processing information. Also, many neurodivergent users face more challenges remembering things. Some neurodivergent users struggle with organizational tasks such as planning long-term goals, time management, following and creating routines, and prioritizing the most important tasks.

This disclosure provides various techniques for generating memory bookmarks for electronically captured visual information in consumer electronic devices. As described in more detail below, the disclosed embodiments use computer vision and deep learning artificial intelligence (AI) technologies to derive essential information from screenshots or photos (usually taken to remember information) and take purposeful action based on that information. The disclosed embodiments provide automated actions, dynamic metadata, and effective context-related resurfacing of screenshot content to effectively fulfill a screenshot's intention to remind a user of critical information and streamline the user's daily life tasks that rely on that information.

Note that while some of the embodiments discussed below are described in the context of use in consumer electronic devices (such as smartphones), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for memory bookmarks for electronically captured visual information in consumer electronic devices.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for memory bookmarks for electronically captured visual information in consumer electronic devices as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for memory bookmarks for electronically captured visual information in consumer electronic devices.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

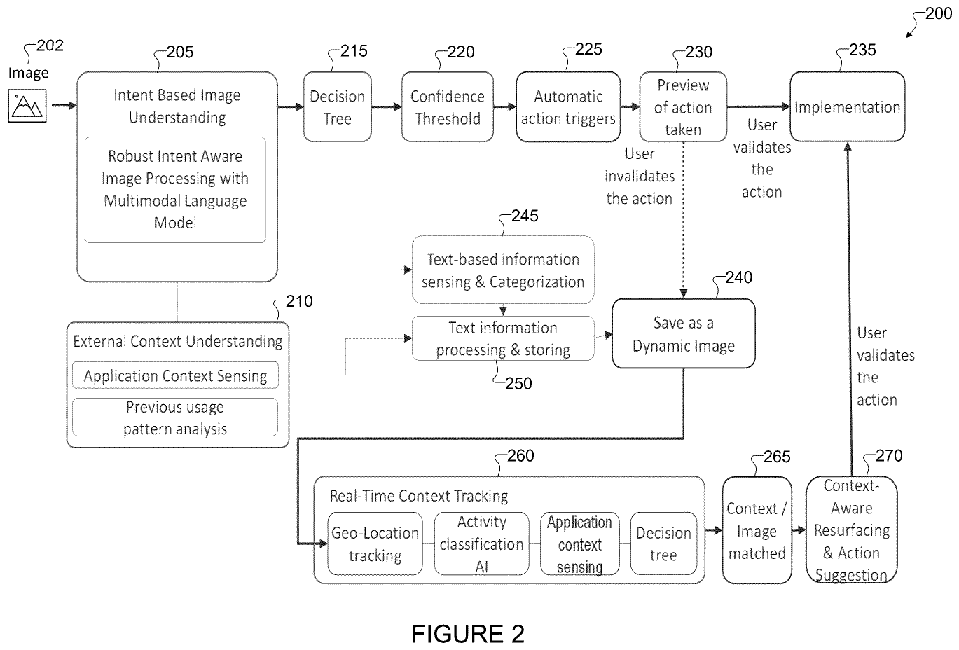

FIG. 2 illustrates an example process 200 for generating and using memory bookmarks for electronically captured visual information according to this disclosure. For ease of explanation, the process 200 is described as being implemented using one or more components of the network configuration 100 of FIG. 1 described above, such as the electronic device 101. However, this is merely one example, and the process 200 could be implemented using any other suitable device(s) (such as the server 106) and in any other suitable system(s).

As shown in FIG. 2, the process 200 includes the electronic device 101 obtaining an image 202 that is captured in response to an input from a user. For example, the image 202 can be a screenshot of the display of the electronic device 101 that is captured by the user, or the image 202 can be a photo of a scene that the user captures, e.g., using a camera of the electronic device 101.

After obtaining the image 202, the electronic device 101 performs an intent-based image understanding process 205 using the image 202. The intent-based image understanding process 205 processes the image 202 to extract information from the image 202. In particular, the intent-based image understanding process 205 uses computer vision techniques to extract visual and text information from the image 202. Here, the computer vision techniques can include intent aware image processing with a multimodal language model system.

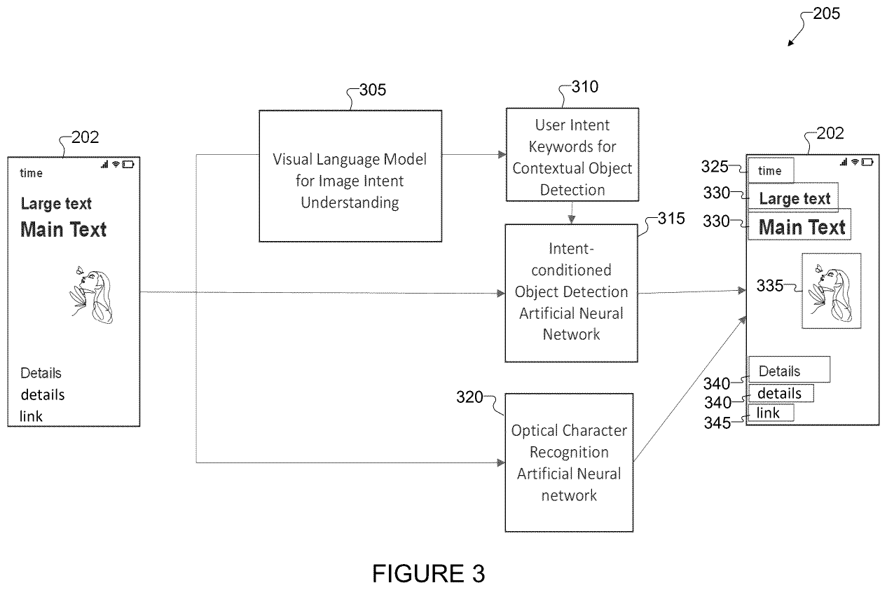

FIG. 3 illustrates further details of the intent-based image understanding process 205 according to this disclosure. As shown in FIG. 3, the electronic device 101 performs the intent-based image understanding process 205 using a system of artificial neural networks (ANNs), which are trained on a dataset of screenshot images for object detection, optical character recognition (OCR), and intent recognition to generate structured data. The system of ANNs includes a visual language model 305 for image intent understanding, an intent-conditioned object detection neural network 315, and an OCR neural network 320.

The visual language model 305 processes the image 202 to extract user intent keywords 310 for contextual object detection. In some embodiments, the visual language model 305 is a custom computer vision model that uses deep learning technology to process the image 202. In some embodiments, the visual language model 305 can provide detailed responses (comprising not only image descriptions, but also synthesized data like summaries and assumptions) in response to queries regarding images. This enables the electronic device 101 to predict the user intentions or probable subsequent actions.

The visual language model 305 is trained with a (general) dataset of screen captures, other images, and their identified contents to correlate user intent, keywords, actions, and other suitable information. Research on different users' screenshot usage and intention patterns has shown that there are a few main reasons why people take photos and screenshots. This provides a starting basis for training the visual language model 305 to recognize certain keywords.

The visual language model 305 can produce multiple predictions of the contents of the image 202, including the application associated with the image 202, the current context in the application, and the user's current activity in the application.

In some embodiments, the visual language model 305 is also trained to detect boundaries of objects in images. By using the visual language model 305 to extract the user intent keywords 310, this enables the intent-conditioned object detection neural network 315, which takes advantage of common sense understanding of the language model to determine the user's intent. The OCR neural network 320 extracts all text from the image 202. As a result of the intent-based image understanding process 205, the electronic device 101 is able to extract various information from the image 202, including time and date information 325, text image 330, image information 335, other details 340, one or more hyperlinks 345, and any other suitable information.

In addition, the electronic device 101 also performs an external context understanding process 210 using the image 202, which can be simultaneous with, or in series with, the intent-based image understanding process 205. The external context understanding process 210 includes application context sensing and previous usage pattern analysis to collect information about the background system information and analyze how the type of image 202 was utilized (including if any information has been stored with the image 202). The application context sensing can use one or more accessibility APIs available to the electronic device 101 to help determine the current activity of the user.

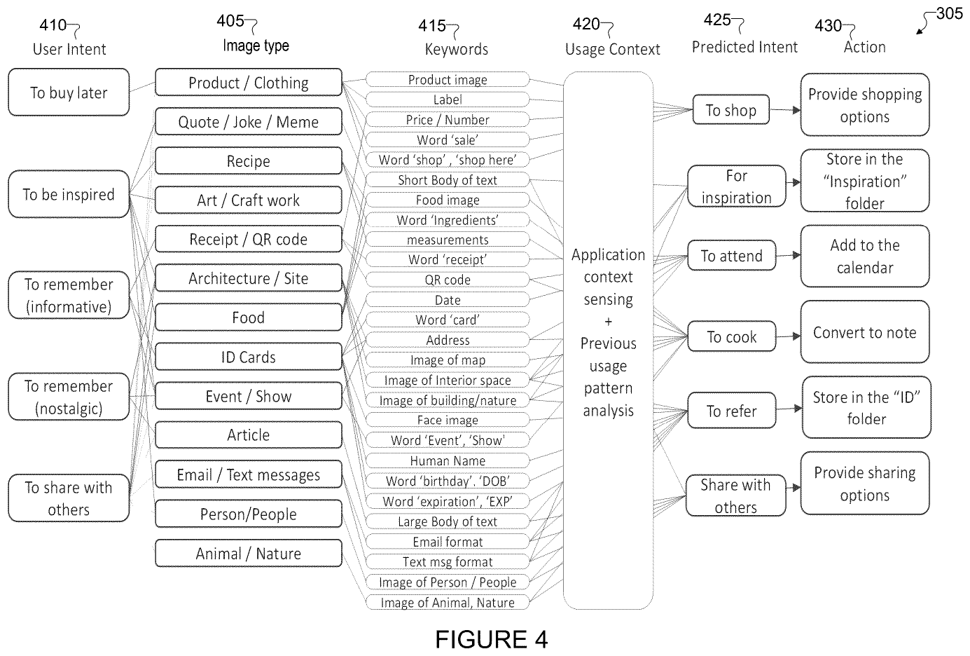

FIG. 4 illustrates further details of one example of the intent-based image understanding process 205 and the external context understanding process 210 according to this disclosure. As described above, the electronic device 101 can process the image 202 by performing the intent-based image understanding process 205 and the external context understanding process 210. As shown in FIG. 4, as a result of the processes 205 and 210, the electronic device 101 can determine an image type 405 associated with the image 202. The image type 405 can indicate the type of information in the image 202, such as a product, a joke or meme, an article, a person, or the like. The electronic device 101 can also determine a likely user intent 410 for taking or capturing the image 202, such as to buy later, to be inspired, or to remember. The electronic device 101 can also determine one or more keywords 415 that are associated with the image 202. Using previous usage context 420 of the user, along with image type 405, the user intent 410, and the keywords 415, the electronic device 101 can determine a predicted intent 425 of the user (e.g., shopping, attending, cooking, and the like), which can lead to the electronic device 101 suggesting an action 430 to the user, as described in greater detail below.

Turning again to FIG. 2, after the electronic device 101 performs the intent-based image understanding process 205 and the external context understanding process 210, the electronic device 101 has an estimated understanding of the user's intention and the purpose of the user capturing the image 202. With that understanding, the electronic device 101 can trigger one or more automatic actions 225 to fulfill what the user has intended.

The electronic device 101 can navigate a decision tree 215 using both the predicted application contents and the predicted text, in order to determine which automatic action 225 will be recommended for the user. The predicted application contents and the predicted text can help determine the automatic action 225 to recommend. In particular, this data can be used to corroborate the predictions from the visual language model 305. Once the electronic device 101 determines that the predictions are accurate (such as by comparing to one or more confidence thresholds 220), and identifies the automatic action 225 and the application to perform it, the electronic device 101 recommends the automatic action 225 to the user. The electronic device 101 can also prompt the user with a preview 230 of the automatic action to be taken, such as by displaying the automatic action 225 on a user interface of the electronic device 101. The user can either validate the automatic action 225, in which case the electronic device 101 automatically performs or implements the automatic action 225 (as indicated at 235), or the user can invalidate the automatic action 225, in which case the electronic device 101 does not implement the automatic action 225.

Depending on the image type 405 associated with the image 202, there may be more than one recommended automatic action 225. For example, if the image type 405 includes an event, the electronic device 101 may recommend one automatic action 225 to add the event to the user's calendar, and recommend another automatic action 225 to share the event with one or more user contacts.

The automatic action 225 provides advantageous benefits over existing solutions. For example, some existing solutions can provide a set of actions (e.g., share, copy text, etc.) after a screenshot is taken. However, these actions are simply presented as a predetermined list, and the user must complete the action manually. With the automatic action function of the process 200, the electronic device 101 can intelligently determine an automatic action 225 that is based on the current context. In addition, the electronic device 101 can immediately and automatically perform the automatic action 225 for the user, which ensures that the screenshot/photo content is fulfilling its purpose. It also prevents screenshot and photo images from sitting in the camera roll and being unactionable.

If the user invalidates the automatic action 225 (i.e., declines an opportunity to perform the automatic action 225), then the electronic device 101 saves the image 202 into the camera roll or photo app as a dynamic image 240. To better understand a dynamic image 240, it is helpful to consider a typical static image. Typically, a stored image in the camera roll of an electronic device is a static image that cannot be interacted with. That is, the static image does not include any controls, links, or other actionable elements that a user can interact with. Therefore, such static images are not easy to be used as a reference. In contrast, a dynamic image 240 includes one or more interactive elements that allow the user to perform one or more actions associated with the dynamic image.

For example, assume a user is browsing stories on a social media site and comes across an event that the user is interested in possibly attending in the future. To remember this event, the user takes a screenshot showing the event. The screenshot may include image information of clickable elements within the social media site, such as a link to the company's social media account or website or a searchable image. The electronic device 101 can save the screenshot as a dynamic image 240 that maintains the clickable elements.

To save the image 202 as a dynamic image, the electronic device 101 performs operations 245 and 250. In operation 245, the electronic device 101 uses computer vision techniques from the intent-based image understanding process 205 to detect and extract the visual data (texts, web links, images, and the like) and interactive elements on the image 202. In operation 250, the electronic device 101 uses the application context sensing module that is part of the external context understanding process 210 to access information about the user's activity. This can include text, text format web links, images, the predicted application, the predicted user activity, and other metadata. The electronic device 101 can then render an application preview using the image 202 and related information. In doing so, the electronic device 101 can generate UI elements in the image 202 that are clickable according to the predicted application. When the electronic device 101 stores the image 202 as a dynamic image 240, the electronic device 101 converts the visual data and interactive elements into the clickable elements.

When the user re-opens the dynamic image 240, the dynamic image 240 functions as a “live” image that acts similarly to the source screen. That is, the dynamic image 240 is more interactive than a standard image 202. For example, if the image 202 is a screen of a music player, the corresponding dynamic image 240 may include one or more interactive controls that allow the user to play music directly from the dynamic image 240 of the music player.

In some embodiments, the electronic device 101 stores the image 202 as a dynamic image 240 while avoiding application sandboxing. Application sandboxing seeks to improve security by isolating and shielding software from outside intruders or malware. Due to application sandboxing, most third party applications are restricted from directly accessing information (such as metadata) about other currently running applications.

To avoid this issue, the electronic device 101 stores the predicted contents from the intent-based image understanding process 205 and the external context understanding process 210 at the time of screenshot capture. In particular, the electronic device 101 can use first party APIs, or accessibility APIs, to circumvent this sandbox and access information about the user's activity. These APIs make on-screen contents directly accessible to other applications for the purposes of offering screen readers and other accessibility accommodations This can include whatever the application developer has made available for the screen readers and other similar systems. Typically this exposes an abundance of information regarding the current application's context, user activity, on screen information, and available actions on screen, such as input fields, buttons, links, and the like.

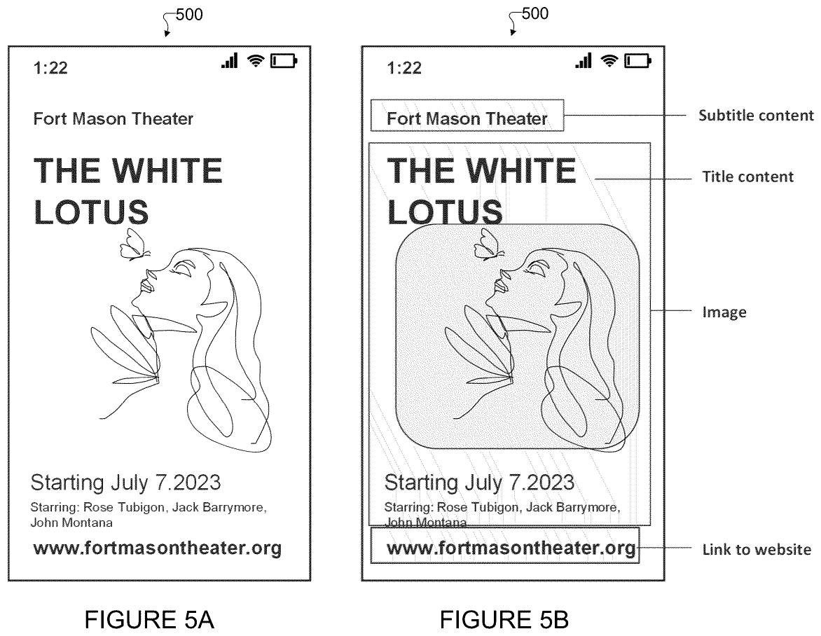

As an example, FIGS. 5A and 5B illustrate an example image 500 from which information can be extracted using accessibility APIs according to this disclosure. As shown in FIG. 5A, the image 500 is a screenshot from a social media platform. The image 500 can represent the image 202 of FIG. 2. In FIG. 5B, various information elements have been extracted from the image 500 by the electronic device 101, including title content, subtitle content, one or more images, and one or more web links or hyperlinks. The electronic device 101 can use these information elements in generating the dynamic image 240. For example, the dynamic image 240 can include user-selectable text, a web link, a predicted application corresponding to the dynamic image 240, a predicted user activity, or any combination of these. The electronic device 101 can then store the dynamic image 240 for later use, as described below.

When the image 202 is saved as the dynamic image 240, the electronic device 101 can use the screenshot-tuned computer vision model, the OCR model, and the application context sensing techniques to understand the user's specific context when interacting with their device at that specific moment.

Later, after the dynamic image 240 is stored, the electronic device 101 can perform a real-time context tracking operation 260 to continuously determine the current context of the user. The electronic device 101 can then determine the relevance of the stored dynamic images 240 to that current user context by comparing the current user context to the context associated with each dynamic image 240. If any of the stored dynamic images 240 are relevant to the current context of the user, the electronic device 101 can display that dynamic image 240 to the user and suggest at least one automatic action to the user. This can also be referred to as “resurfacing” the dynamic image 240.

In the real-time context tracking operation 260, the electronic device 101 can use AI behavioral classification techniques to learn the behaviors and contexts of the user over time. Here, a current context of the user can include a location of the user, an application used by the user, user data from the application used by the user, an activity of the user (e.g., what the user is doing on their device), a current day and time, user biometrics, and the like.

In some embodiments, the electronic device 101 can use accessibility APIs to access information about the user's current activity. The electronic device 101 can then use this information to determine the current user context. The electronic device 101 can also use one or more activity classification APIs or activity recognition APIs to automatically detect user activities by periodically reading short bursts of sensor data and processing them using machine learning models. These activities can also be used to determine the user's current context. Once the current context is determined, the electronic device 101 can implement a decision tree to determine when the user's current context matches that of a previously saved dynamic image 240. In some embodiments, the decision tree can include a machine learning model trained on features of activity pairs to determine to match.

When the electronic device 101 determines that the current context of the user matches a previous context of the user associated with a dynamic image 240 (as indicated at 265), then the electronic device performs operation 270, in which the electronic device 101 resurfaces the dynamic image 240 to the user and suggests an automatic action to the user. The automatic action may be the automatic action 225 suggested earlier by the electronic device 101 or may be a different action.

As an example, assume that the user takes a screenshot of a café that the user saw on social media. The screenshot includes address information of the café. When the screenshot is saved as a dynamic image 240, the address information is captured and saved with the dynamic image 240. Later, when the electronic device 101 determines that the user is in physical proximity to the café (such as by using geo-location tracking), the electronic device 101 can resurface the dynamic image 240 with a note that the café is nearby.

As another example, assume that the user takes a screenshot of a product that the user may want to purchase or learn more about in the future. The screenshot includes image information of the product. Later, when the user is shopping on Amazon or another shopping site, the electronic device 101 can resurface the dynamic image 240 with a reminder to purchase or learn more about the product.

The resurfacing of the dynamic image 240 and the suggested action serve as a reminder or nudge to the user by bringing the context of the dynamic image 240 to the user's attention at the right time and in the right place. If the user is currently using an application in the electronic device 101, the electronic can display the dynamic image 240 while the user is using the application. For certain applications that are more general and do not correspond to a particular activity (e.g., a web browser or a note-taking application), the electronic device 101 can use the accessibility APIs to determine the user's specific activity and whether it is relevant.

Although FIGS. 2 through 5 illustrate one example of a process 200 for generating and using memory bookmarks for electronically captured visual information and related details, various changes may be made to FIGS. 2 through 5. For example, while the process 200 is described as involving specific sequences of operations, various operations described with respect to FIGS. 2 through 5 could overlap, occur in parallel, occur in a different order, or occur any number of times (including zero times). Also, the specific operations shown in FIGS. 2 through 5 are examples only, and other techniques could be used to perform each of the operations shown in FIGS. 2 through 5.

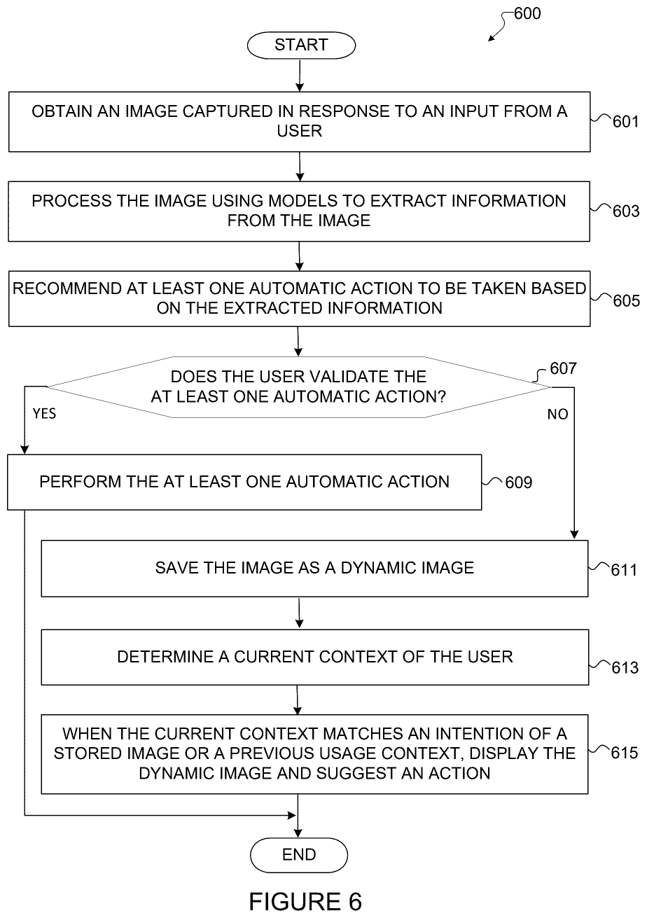

FIG. 6 illustrates an example method 600 for generating and using memory bookmarks for electronically captured visual information according to this disclosure. For ease of explanation, the method 600 shown in FIG. 6 is described as being performed using the electronic device 101 shown in FIG. 1 and the process 200 shown in FIGS. 2 through 5. However, the method 600 shown in FIG. 6 could be used with any other suitable device(s) or system(s) and could be used to perform any other suitable process(es).

As shown in FIG. 6, at step 601, an image captured in response to an input from a user is obtained. The image comprises a screenshot or a photo. This could include, for example, the electronic device 101 capturing the image 202, such as is shown in FIG. 2.

At step 603, the image is processed using an intent-based image understanding model and an optical character recognition model to extract information from the image. This could include, for example, the electronic device 101 performing the intent-based image understanding process 205 and the external context understanding process 210 to process the image 202, such as is shown in FIG. 2.

At step 605, at least one automatic action to be taken is recommended based on the extracted information. This could include, for example, the electronic device 101 recommending an automatic action 225 and prompting the user with a preview 230 of the automatic action to be taken, such as is shown in FIG. 2.

At step 607, it is determined if the user validates the at least one automatic action. This could include, for example, the electronic device 101 determining if the user validates the automatic action 225 or invalidates the automatic action 225. If the user validates the automatic action, then the method 600 continues to step 609. Otherwise, the method continues to step 611.

At step 609, the at least one automatic action is performed. This could include, for example, the electronic device 101 automatically performing or implementing the automatic action 225, such as is shown in FIG. 2.

At step 611, the image is saved as a dynamic image. This could include, for example, the electronic device 101 saving the image 202 as a dynamic image 240, such as is shown in FIG. 2.

At step 613, a current context of the user is determined. This could include, for example, the electronic device 101 performing the real-time context tracking operation 260 to determine the user's current context, such as is shown in FIG. 2.

At step 615, in response to determining that the current context of the user matches an intention of a stored image or a previous usage context of the user when the image was captured, displaying the dynamic image and suggesting the at least one automatic action or another action to the user. This could include, for example, the electronic device 101 performing operation 270, in which the electronic device 101 resurfaces the dynamic image 240 to the user and suggests an automatic action to the user, such as is shown in FIG. 2.

Although FIG. 6 illustrates one example of a method 600 for generating and using memory bookmarks for electronically captured visual information, various changes may be made to FIG. 6. For example, while shown as a series of steps, various steps in FIG. 6 could overlap, occur in parallel, occur in a different order, or occur any number of times (including zero times).

The disclosed embodiments are suitable for a wide variety of use cases in order to help the user fall out of the memory cycle where the user takes a photo or screenshot to remember something but then forgets about it. For instance, the disclosed embodiments can recommend automatic actions related to shopping, automatic scheduling, or any other suitable activity. For example, if a user takes a screenshot of a book that the user saw on social media, the system could automatically prompt the user with various shopping options, and the item could be automatically added to their shopping cart. If the user takes an photo image of a dry cleaning pickup slip, the system could read date information from the pickup slip, and then prompt the user to automatically add the pickup date to the user's calendar. Of course, other use cases are possible and within the scope of this disclosure.

Note that the operations and functions shown in or described with respect to FIGS. 2 through 6 can be implemented in an electronic device 101, 102, 104, server 106, or other device(s) in any suitable manner. For example, in some embodiments, the operations and functions shown in or described with respect to FIGS. 2 through 6 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 6 can be implemented or supported using dedicated hardware components. In general, the operations and functions shown in or described with respect to FIGS. 2 through 6 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, by a processor, an image captured in response to an input from a user, the image comprising a screenshot or a photo;
processing, by the processor, the image using an intent-based image understanding model and an optical character recognition model to extract information from the image;
recommending, by the processor, at least one automatic action to be taken based on the extracted information; and
in response to a validation by the user of the at least one automatic action, performing, by the processor, the at least one automatic action.

2. The method of claim 1, wherein recommending, by the processor, the at least one automatic action comprises:
generating one or more predictions associated with a content of the image;
selecting the at least one automatic action using a decision tree and the one or more predictions; and
displaying the at least one automatic action on a user interface.

3. The method of claim 1, wherein the intent-based image understanding model is trained using screen capture data to correlate user intent, keywords, and actions.

4. The method of claim 1, further comprising:
in response to an invalidation by the user of the at least one automatic action, saving the image as a dynamic image that includes one or more of: user-selectable text, a web link, a predicted application corresponding to the image, and a predicted user activity corresponding to the image.

5. The method of claim 4, wherein saving the image as the dynamic image comprises:
using one or more accessibility APIs to save the image as the dynamic image.

6. The method of claim 4, further comprising:
determining a current context of the user after the image is saved as the dynamic image; and
in response to determining that the current context of the user matches a previous context of the user when the image was captured, displaying the dynamic image and suggesting the at least one automatic action or another action to the user.

7. The method of claim 6, wherein the current context of the user comprises at least one of: a location of the user, an application used by the user, user data from the application used by the user, and an activity of the user.

8. An electronic device comprising:
at least one processing device configured to:
obtain an image captured in response to an input from a user, the image comprising a screenshot or a photo;
process the image using an intent-based image understanding model and an optical character recognition model to extract information from the image;
recommend at least one automatic action to be taken based on the extracted information; and
in response to a validation by the user of the at least one automatic action, perform the at least one automatic action.

9. The electronic device of claim 8, wherein to recommend the at least one automatic action, the at least one processing device is configured to:
generate one or more predictions associated with a content of the image;
select the at least one automatic action using a decision tree and the one or more predictions; and
control the electronic device to display the at least one automatic action on a user interface.

10. The electronic device of claim 8, wherein the intent-based image understanding model is trained using screen capture data to correlate user intent, keywords, and actions.

11. The electronic device of claim 8, wherein the at least one processing device is further configured to:
in response to an invalidation by the user of the at least one automatic action, save the image as a dynamic image that includes one or more of: user-selectable text, a web link, a predicted application corresponding to the image, and a predicted user activity corresponding to the image.

12. The electronic device of claim 11, wherein the at least one processing device is configured to use one or more accessibility APIs to save the image as the dynamic image.

13. The electronic device of claim 11, wherein the at least one processing device is further configured to:
determine a current context of the user after the image is saved as the dynamic image; and
in response to determining that the current context of the user matches a previous context of the user when the image was captured, display the dynamic image and suggest the at least one automatic action or another action to the user.

14. The electronic device of claim 13, wherein the current context of the user comprises at least one of: a location of the user, an application used by the user, user data from the application used by the user, and an activity of the user.

15. A non-transitory machine-readable medium containing instructions that when executed cause at least one processor of an electronic device to:
obtain an image captured in response to an input from a user, the image comprising a screenshot or a photo;
process the image using an intent-based image understanding model and an optical character recognition model to extract information from the image;
recommend at least one automatic action to be taken based on the extracted information; and
in response to a validation by the user of the at least one automatic action, perform the at least one automatic action.

16. The non-transitory machine-readable medium of claim 15, wherein the instructions to recommend the at least one automatic action comprise instructions to:
generate one or more predictions associated with a content of the image;
select the at least one automatic action using a decision tree and the one or more predictions; and
control the electronic device to display the at least one automatic action on a user interface.

17. The non-transitory machine-readable medium of claim 15, wherein the intent-based image understanding model is trained using screen capture data to correlate user intent, keywords, and actions.

18. The non-transitory machine-readable medium of claim 15, wherein the instructions further cause the at least one processor to:
in response to an invalidation by the user of the at least one automatic action, save the image as a dynamic image that includes one or more of: user-selectable text, a web link, a predicted application corresponding to the image, and a predicted user activity corresponding to the image.

19. The non-transitory machine-readable medium of claim 18, wherein the instructions further cause the at least one processor to use one or more accessibility APIs to save the image as the dynamic image.

20. The non-transitory machine-readable medium of claim 18, wherein the instructions further cause the at least one processor to:
determine a current context of the user after the image is saved as the dynamic image; and
in response to determining that the current context of the user matches a previous context of the user when the image was captured, display the dynamic image and suggest the at least one automatic action or another action to the user.
